(19) United States
(12) Patent Application Publication
(10) Pub. No.: US 2025/0294498 A1
(43) Pub. Date: Sep. 18, 2025

(54) MESSAGING SCHEDULE FOR ULTRA-WIDEBAND (UWB) POSITIONING

(71) Applicant: QUALCOMM Incorporated, San Diego, CA (US)

(72) Inventors: Varun Amar REDDY, San Diego, CA (US); Aleksandar DAMNJANOVIC, Del Mar, CA (US); Krishna Kiran MUKKAVILLI, San Diego, CA (US)

(21) Appl. No.: 18/603,829

(22) Filed: Mar. 13, 2024

(51) Int. Cl. H04W 64/00; H04L 5/00; H04W 24/10

(52) U.S. Cl. CPC H04W 64/00; H04L 5/0053; H04W 24/10

(57) ABSTRACT

Disclosed are techniques for wireless communication. In an aspect, an initiator device may transmit, based on a first messaging schedule, a ranging initiation message to a plurality of responder devices based on a first radio access technology (RAT). The initiator device may receive one or more ranging response messages from a first subset of the plurality of responder devices based on the first RAT, the one or more ranging response messages acknowledging reception of the ranging initiation message. The initiator device may transmit a first measurement report message to the plurality of responder devices based on a second RAT. The first measurement report message indicates the first subset of the plurality of responder devices as available for single-sided two-way ranging, a second subset of the plurality of responder devices as unavailable for two-way ranging, or both.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

Moreover, a fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements.

Also, there are other wireless communication systems developed for communications with an effective range shorter than that of the aforementioned wireless communication systems (e.g., LTE, WiMax, or 5G). The other wireless communication systems for short-range communications may be based on a radio access technology (RAT) such as WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc. In some aspects, these other wireless communication systems for short-range communications may be designed to provide data communications as well as positioning or ranging services.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating an initiator device includes transmitting, based on a first messaging schedule for a current ranging round, a ranging initiation message to a plurality of responder devices based on a first radio access technology (RAT); receiving, based on the first messaging schedule, one or more ranging response messages from a first subset of the plurality of responder devices based on the first RAT, the one or more ranging response messages acknowledging reception of the ranging initiation message; and transmitting, based on the first messaging schedule, a first measurement report message to the plurality of responder devices based on a second RAT, wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

In an aspect, an initiator device includes one or more memories; one or more transceivers; and one or more processors communicatively coupled to the one or more memories and the one or more transceivers, the one or more processors, either alone or in combination, configured to: transmit, via the one or more transceivers based on a first messaging schedule for a current ranging round, a ranging initiation message to a plurality of responder devices based on a first radio access technology (RAT); receive, via the one or more transceivers based on the first messaging schedule, one or more ranging response messages from a first subset of the plurality of responder devices based on the first RAT, the one or more ranging response messages acknowledging reception of the ranging initiation message; and transmit, via the one or more transceivers, based on the first messaging schedule, a first measurement report message to the plurality of responder devices based on a second RAT, wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

In an aspect, an initiator device includes means for transmitting, based on a first messaging schedule for a current ranging round, a ranging initiation message to a plurality of responder devices based on a first radio access technology (RAT); means for receiving, based on the first messaging schedule, one or more ranging response messages from a first subset of the plurality of responder devices based on the first RAT, the one or more ranging response messages acknowledging reception of the ranging initiation message; and means for transmitting, based on the first messaging schedule, a first measurement report message to the plurality of responder devices based on a second RAT, wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

In an aspect, a non-transitory computer-readable medium stores computer-executable instructions that, when executed by an initiator device, cause the initiator device to: transmit, based on a first messaging schedule for a current ranging round, a ranging initiation message to a plurality of responder devices based on a first radio access technology (RAT); receive, based on the first messaging schedule, one or more ranging response messages from a first subset of the plurality of responder devices based on the first RAT, the one or more ranging response messages acknowledging reception of the ranging initiation message; and transmit, based on the first messaging schedule, a first measurement report message to the plurality of responder devices based on a second RAT, wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example application of a positioning procedure based on a short-range wireless communication system, according to aspects of the disclosure.

FIG. 2 is a diagram showing the frequency bands of various radio access technologies (RATs), according to aspects of the disclosure.

FIG. 3 illustrates an example architecture of a wireless communication device, according to various aspects of the disclosure.

FIGS. 4A and 4B are diagrams illustrating example ranging operations, according to aspects of the disclosure.

FIG. 5 is a diagram illustrating a double-sided two-way ranging (DS-TWR) procedure, according to aspects of the disclosure.

FIG. 6 is a diagram illustrating a single-sided two-way ranging (SS-TWR) procedure, according to aspects of the disclosure.

FIG. 7 is a diagram illustrating an example ranging block structure, according to aspects of the disclosure.

FIG. 8 is a diagram illustrating an example ranging round for performing a positioning procedure, according to aspects of the disclosure.

FIG. 9 is a diagram illustrating another example ranging round for performing a positioning procedure, according to aspects of the disclosure.

FIG. 10 is a diagram illustrating a message flow for performing a positioning procedure, according to aspects of the disclosure.

FIG. 11 is a flowchart illustrating a method of operating a sensing node device, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to messaging schedule for ultra-wideband (UWB) positioning. Some aspects more specifically relate to implementing a retransmission scheme for message affected by interference in a positioning procedure based on an ultra-wideband radio access technology (RAT).

Particular aspects of the subject matter described in this disclosure can be implemented to realize one or more of the following potential advantages. In some examples, an initiator device may determine whether each of the responder devices is available for a single-sided two-way ranging (SS-TWR) procedure and/or a double-sided two-way ranging (DS-TWR) procedure based on the messages transmitted or received according to a first messaging schedule, and determine a second messaging schedule or a supplemental messaging schedule for retransmission. Accordingly, the retransmission of dropped messages may be performed with reduced overhead, and a positioning procedure may thus be timely performed with improved accuracy.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

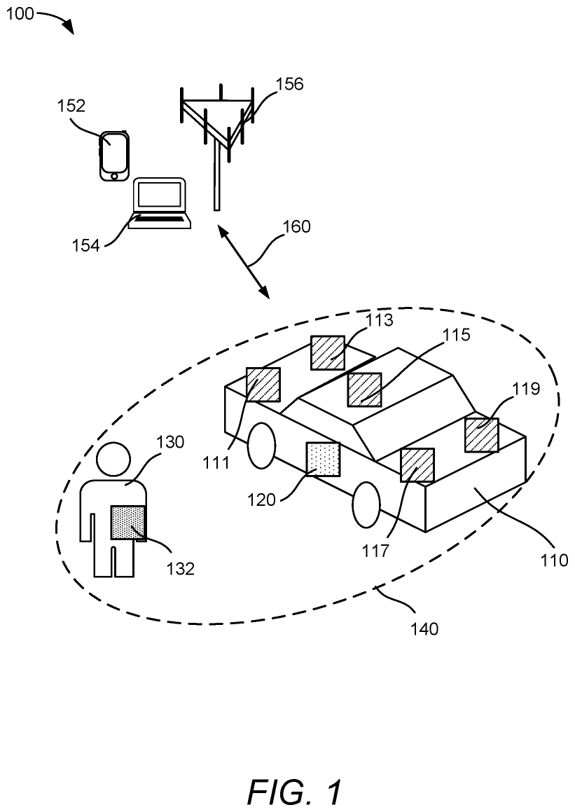

FIG. 1 illustrates an example application of a positioning procedure based on a short-range wireless communication system, according to aspects of the disclosure. As shown in FIG. 1, as a non-limiting example, a vehicle 110 may include responder devices 111, 113, 115, 117, and 119 installed therein. The vehicle 110 may include a processing device 120 installed therein. In some aspects, the processing device 120 may be communicatively coupled to the responder devices 111, 113, 115, 117, and 119 and may be configured to control the operations of the responder devices 111, 113, 115, 117, and 119. In some aspects, the processing device 120 may be implemented as a computer onboard the vehicle 110 different from the responder devices 111, 113, 115, 117, and 119. In some aspects, the processing device 120 may be incorporated in one of the responder devices 111, 113, 115, 117, and 119. Moreover, in this a non-limiting example, a user 130 may carry an initiator device 132.

In some aspects, the initiator device 132 may be configured to communicate with the responder devices 111, 113, 115, 117, and 119 based on at least a first radio access technology (RAT) in order to perform a positioning procedure to determine a position of the initiator device 132 with respect to the responder devices 111, 113, 115, 117, and 119. In some aspects, the processing device 120 may determine if the position of the initiator device 132 is within a range 140 of the vehicle 110 in order to determine whether one or more functions of the vehicle 110 should be activated or deactivated (e.g., unlock the door, start the engine, start the air conditioning, etc.). In addition, the initiator device 132 may be configured to communicate with the responder devices 111, 113, 115, 117, and 119 based on the first RAT or a second RAT for data communication.

In some aspects, the first RAT may corresponds to an ultra-wideband radio access technology (e.g., ultra-wideband (UWB)) based on a first channel bandwidth. In some aspects, the second RAT may correspond to a short-range radio access technology (e.g., WiFi, Bluetooth®, or near-field communication (NFC)) based on a second channel bandwidth that is one-third or less of the first channel bandwidth.

In some aspects, the UWB devices may use pulse-based radio signaling (e.g. Short-pulse-UWB) instead of OFDM-based signaling (Multi-Band OFDM UWB). Short-pulse-UWB signaling transmits with the energy for each bit spread over the entire UWB channel bandwidth (e.g., 1.37 GHz, 4 GHz, etc.) with varying pulse amplitude and/or pulse polarity without using a RF carrier while MB-OFDM (Multi-Band-OFDM) transmits each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g. Gaussian pulses, Monocycle pulses, Hermite pulses, etc) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high speed Analog-to-Digital converter (ADC) and a high speed Digital-to-Analog Converter (DAC) to be able to handle the very wide frequency band used; however, there may be other ways to handle the need for ultra-fast sampling such as using Time Hopping techniques, Direct Sequence coding techniques, etc.

Multiband OFDM UWB divides up spectrum into several frequency sub-bands and OFDM is applied within each band; whereas, other OFDM systems typically operate within a fixed frequency band. The complex waveform created by combining the multiple-sub-bands results in a final waveform that used for transmission for Multiband OFDM UWB. Multiband OFDM UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

In some aspects, as shown in FIG. 1, other devices (e.g., a cell phone 152, a computer 154, and/or a base station 156) may communicate based on RATs such as 2G, 3G, LTE, 5G, WiFi, etc. In some aspects, the wireless communications performed by the other devices 152, 254, and/or 156 may interfere with the wireless communications between the initiator device 132 and the responder devices 111, 113, 115, 117, and 119 based on the first RAT (e.g., the interference being depicted as arrow 160 in FIG. 1).

In some aspects, a RAT according to 2G, 3G, LTE, 5G, and/or WiFi may arrange the available radio frequency (RF) resources into narrower RF bands. In some aspects, data transmitted using the RAT according to 2G, 3G, LTE, 5G, and/or WiFi may be modulated into an RF signal based on using an RF sinusoidal signal as a carrier at a designated frequency of each band. In some aspects, a receiver of the RAT according to 2G, 3G, LTE, 5G, and/or WiFi may distinguish the signals (intended for the receiver) from noises (including background noises and other signals not intended for the receiver) in the frequency domain based on a filter with a central frequency matching the frequency of the carrier.

In contrast, UWB (e.g., short-pulse-UWB) may use a pulse that has a short duration in the time domain with a low energy level for short-range, high-bandwidth communications over a large portion of the radio spectrum. UWB has traditionally been used for non-cooperative radar imaging, and more recently, for sensor data collection, precision locating, and tracking applications. In some aspects, data transmitted using UWB may be based on varying pulse amplitude and/or pulse polarity without using an RF carrier.

In some aspects, a receiver according to UWB may distinguish the signals from noises in the time domain based on synchronization and/or a pulse template for the UWB communication.

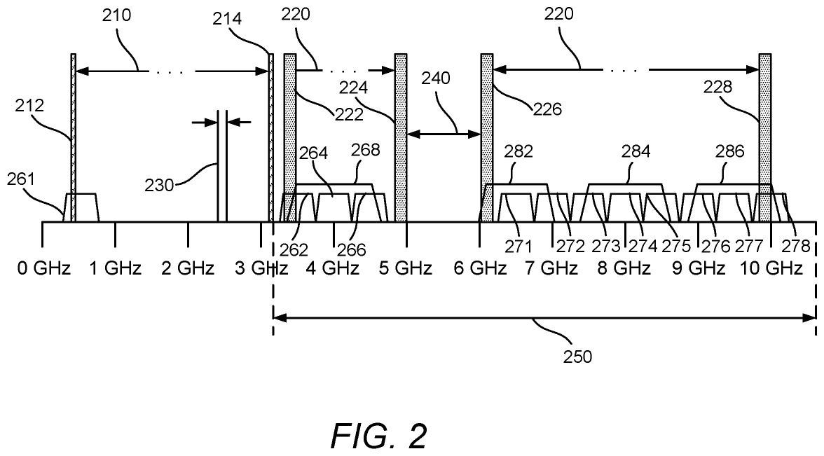

FIG. 2 is a diagram showing the frequency bands of various RATs, according to aspects of the disclosure. In FIG. 2, the frequency is represented horizontally and increasing from left to right. As shown in FIG. 2, the 2G, 3G, and/or 4G may use at least various frequency bands 210, including, e.g., frequency bands 212 and 214, with central frequencies ranging from about 400 MHz to 3.1 GHz. In some aspects, the 5G may use at least various frequency bands 220, including, e.g., frequency bands 222, 224, 226, and 228, with central frequencies ranging from about 3.2 GHz to 5.0 GHz and 6 GHz to 10 GHz. In some aspects, WiFi based on the Institute of Electrical and Electronics Engineers (IEEE) 802.11b/g specification may have channels 220 with central frequencies ranging from about 2.4 MHz to 2.5 MHz. In some aspects, WiFi based on the IEEE 802.11a/n specification may have channels 240 with central frequencies ranging from about 5 GHz to 6 GHz. In some aspects, these bands and channels illustrated in FIG. 2 are merely non-limiting examples depicted in a simplified manner.

As shown in FIG. 2, in some aspects, the United States Federal Communications Commission (FCC) has authorized the UWB applications within at least the frequency range 250 from 3.1 GHz to 10.6 GHz. In some aspects, the UWB may be configured to use a channel 261 (e.g., identified as Channel #0 in some UWB specifications) with a central frequency at about 500 MHz (e.g., 499.2 MHz) and a bandwidth of about 500 MHz (e.g., 499.2 MHz). In some aspects, channel 261 is also referred to as in a sub-GHz band.

In some aspects, the UWB may be configured to use channels 262, 264, and 266 (e.g., respectively identified as Channel #1, #2, and #3 in some UWB specifications) with central frequencies at about 3.5 GHz (e.g., 3.4944 GHz), 4.0 GHz (e.g., 3.9936 GHz), and 4.5 GHz (e.g., 4.4928 GHz), and a bandwidth of about 500 MHz (e.g., 499.2 MHz). In some aspects, the UWB may be configured to use a channel 268 (e.g., identified as Channel #4 in some UWB specifications) with a central frequency at about 4.0 GHz (e.g., 3.9936 GHz) and a bandwidth of about 1300 MHz (e.g., 1331.2 MHz). In some aspects, channels 262, 264, 266, and 268 are also referred to as in a low band.

In some aspects, the UWB may be configured to use channels 271, 272, 273, 274, 275, 276, 277, and 278 (e.g., respectively identified as Channel #5, #6, #8, #9, #10, #12, #13, and #14 in some UWB specifications) with central frequencies at about 6.5 GHz (e.g., 6.4869 GHz), 7.0 GHz (e.g., 6.9888 GHz), 7.5 GHz (e.g., 7.4880 GHz), 8.0 GHz (e.g., 7.9872 GHz), 8.5 GHz (e.g., 8.4864 GHz), 9.0 GHz (e.g., 9.9856 GHz), 9.5 GHz (e.g., 9.4848 GHz), and 10.0 GHz (e.g., 9.9840 GHz), and a bandwidth of about 500 MHz (e.g., 499.2 MHz). In some aspects, the UWB may be configured to use a channel 282 (e.g., identified as Channel #7 in some UWB specifications) with a central frequency at about 6.5 GHz (e.g., 6.4869 GHz) and a bandwidth of about 1100 MHz (e.g., 1081.6 MHz). In some aspects, the UWB may be configured to use a channel 284 (e.g., identified as Channel #11 in some UWB specifications) with a central frequency at about 8.0 GHz (e.g., 7.9872 GHz) and a bandwidth of about 1300 MHz (e.g., 1331.2 MHz). In some aspects, the UWB may be configured to use a channel 286 (e.g., identified as Channel #15 in some UWB specifications) with a central frequency at about 9.5 GHz (e.g., 9.4848 GHz) and a bandwidth of about 1300 MHz (e.g., 1354.97 MHz). In some aspects, channels 271, 272, 273, 274, 275, 276, 277, 278, 282, 284, and 286 are also referred to as in a high band.

As shown in FIG. 2, any of the RATs that is not UWB may have a channel bandwidth that is one-third or less of the channel bandwidth of the UWB. Also, as the UWB is configured to use channels that overlap with the channels of various non-UWB RATs, the transmissions based on the UWB may be subject to interference caused by the non-UWB RATs.

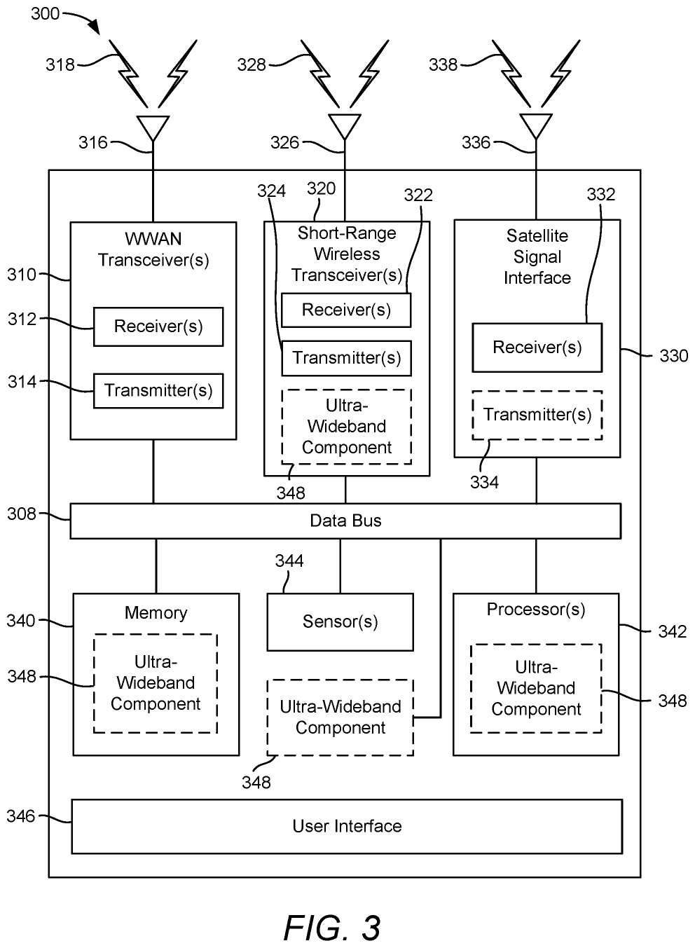

FIG. 3 illustrates an example architecture of a wireless communication device 300, according to various aspects of the disclosure. FIG. 3 illustrates several example components (represented by corresponding blocks) that may be incorporated into the wireless communication device 300 (which may correspond to any of the initiator device or the responder devices illustrated in FIG. 1). It will be appreciated that these components may be implemented in different types of apparatuses in different implementations (e.g., in an application-specific integrated circuit (ASIC), in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The wireless communication device 300 includes, at least in some cases, one or more wireless wide area network (WWAN) transceivers 310 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 310 may each be connected to one or more antennas 316 for communicating with other network nodes, such as other wireless communication devices (e.g., user equipments (UE)s), access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 310 may be variously configured for transmitting and encoding signals 318 (e.g., messages, indications, information, and so on) and, conversely, for receiving and decoding signals 318 (e.g., messages, indications, information, pilots, and so on) in accordance with the designated RAT. Specifically, the one or more WWAN transceivers 310 include one or more transmitters 314 for transmitting and encoding signals 318 and one or more receivers 312 for receiving and decoding signals 318.

The wireless communication device 300 also includes one or more short-range wireless transceivers 320. The one or more short-range wireless transceivers 320 may be connected to one or more antennas 326 and provide means for communicating (e.g., means for transmitting, means for receiving, means for measuring, means for tuning, means for refraining from transmitting, etc.) with other network nodes, such as other wireless communication devices, access points, base stations, etc., via at least one designated RAT (e.g., Wi-Fi, LTE-D, BLUETOOTH®, ZIGBEE®, Z-WAVE®, PC5, DSRC, WAVE, NFC, UWB, etc.) over a wireless communication medium of interest.

The one or more short-range wireless transceivers 320 may be variously configured for transmitting and encoding signals 328 (e.g., messages, indications, information, and so on) and, conversely, for receiving and decoding signals 328 (e.g., messages, indications, information, pilots, and so on) in accordance with the designated RAT. Specifically, the one or more short-range wireless transceivers 320 include one or more transmitters 324 for transmitting and encoding signals 328 and one or more receivers 322 for receiving and decoding signals 328. As specific examples, the one or more short-range wireless transceivers 320 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The wireless communication device 300 also includes, at least in some cases, a satellite signal interface 330, which includes one or more satellite signal receivers 332 and may optionally include one or more satellite signal transmitters 334. The one or more satellite signal receivers 332 may be connected to one or more antennas 336 and may provide means for receiving and/or measuring satellite positioning/communication signals 338.

Where the one or more satellite signal receivers 332 include a satellite positioning system receiver, the satellite positioning/communication signals 338 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the one or more satellite signal receivers 332 include a non-terrestrial network (NTN) receiver, the satellite positioning/communication signals 338 may be communication signals (e.g., carrying control and/or user data) originating from a 5G network. The one or more satellite signal receivers 332 may comprise any suitable hardware and/or software for receiving and processing satellite positioning/communication signals 338. The one or more satellite signal receivers 332 may request information and operations as appropriate from the other systems, and, at least in some cases, perform calculations to determine locations of the wireless communication device 300 using measurements obtained by any suitable satellite positioning system algorithm.

The optional satellite signal transmitter(s) 334, when present, may be connected to the one or more antennas 336 and may provide means for transmitting satellite positioning/communication signals 338. Where the one or more satellite signal transmitters 334 include an NTN transmitter, the satellite positioning/communication signals 338 may be communication signals (e.g., carrying control and/or user data) originating from a 5G network. The one or more satellite signal transmitters 334 may comprise any suitable hardware and/or software for transmitting satellite positioning/communication signals 338. The one or more satellite signal transmitters 334 may request information and operations as appropriate from the other systems.

A transceiver may be configured to communicate over a wired or wireless link. A transceiver (whether a wired transceiver or a wireless transceiver) includes transmitter circuitry (e.g., transmitters 314, 324) and receiver circuitry (e.g., receivers 312, 322). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 314, 324) may include or be coupled to a plurality of antennas (e.g., antennas 316, 326), such as an antenna array, that permits the respective apparatus (e.g., wireless communication device 300) to perform transmit “beamforming,” as described herein. Similarly, wireless receiver circuitry (e.g., receivers 312, 322) may include or be coupled to a plurality of antennas (e.g., antennas 316, 326), such as an antenna array, that permits the respective apparatus (e.g., wireless communication device 300) to perform receive beamforming, as described herein. In an aspect, the transmitter circuitry and receiver circuitry may share the same plurality of antennas (e.g., antennas 316, 326), such that the respective apparatus can only receive or transmit at a given time, not both at the same time. A wireless transceiver (e.g., the one or more WWAN transceivers 310, the one or more short-range wireless transceivers 320) may also include a network listen module (NLM) or the like for performing various measurements.

As used herein, the various wireless transceivers (e.g., transceivers 310, 320) and wired transceivers may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., wireless communication device 300) and a base station will generally relate to signaling via a wireless transceiver.

The wireless communication device 300 also includes other components that may be used in conjunction with the operations as disclosed herein. The wireless communication device 300 includes one or more processors 342 for providing functionality relating to, for example, wireless communication, and for providing other processing functionality.

The one or more processors 342 may therefore provide means for processing, such as means for determining, means for calculating, means for receiving, means for transmitting, means for indicating, etc. In an aspect, the one or more processors 342 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The wireless communication device 300 includes memory circuitry implementing memory 340 (e.g., each including a memory device) for maintaining information (e.g., information indicative of reserved resources, thresholds, parameters, and so on). The memory 340 may therefore provide means for storing, means for retrieving, means for maintaining, etc. In some cases, the wireless communication device 300 may include an ultra-wideband component 348. The ultra-wideband component 348 may be hardware circuits that are part of or coupled to the one or more processors 342 that, when executed, cause the wireless communication device 300 to perform the functionality described herein. In other aspects, the ultra-wideband component 348 may be external to the processors 342 (e.g., part of a modem processing system, integrated with another processing system, etc.). Alternatively, the ultra-wideband component 348 may be a memory module stored in the memory 340 that, when executed by the one or more processors 342 (or a modem processing system, another processing system, etc.), cause the wireless communication device 300 to perform the functionality described herein.

FIG. 3 illustrates possible locations of the ultra-wideband component 348, which may be, for example, part of the one or more short-range wireless transceivers 320, the memory 340, the one or more processors 342, or any combination thereof, or may be a standalone component.

The wireless communication device 300 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include one or more accelerometers (e.g., micro-electrical mechanical systems (MEMS) devices), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems. Note that at least the accelerometer and gyroscope may be referred to as “inertial” sensors.

The various components of the wireless communication device 300 may be communicatively coupled to each other over a data bus 308. In an aspect, the data bus 308 may form, or be part of, a communication interface of the wireless communication device 300.

In addition, the wireless communication device 300 includes a user interface 346 providing means for providing indications (e.g., audible and/or visual indications) to a user and/or for receiving user input (e.g., upon user actuation of a sensing device such a keypad, a touch screen, a microphone, and so on).

For convenience, the wireless communication device 300 is shown in FIG. 3 as including various components that may be configured according to the various examples described herein. It will be appreciated, however, that the illustrated components may have different functionality in different designs. In particular, various components in FIG. 3 are optional in alternative configurations and the various aspects include configurations that may vary due to design choice, costs, use of the device, or other considerations. For example, a particular implementation of wireless communication device 300 may omit the WWAN transceiver(s) 310 (e.g., a wearable device or tablet computer or PC or laptop may have Wi-Fi and/or BLUEOOTH® capability without cellular capability), or may omit the satellite signal interface 330, or may omit the sensor(s) 344, and so on. For brevity, illustration of the various alternative configurations is not provided herein, but would be readily understandable to one skilled in the art.

The components of FIG. 3 may be implemented in various ways. In some implementations, the components of FIG. 3 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 348 may be implemented by processor and memory component(s) of the wireless communication device 300 (e.g., by execution of appropriate code and/or by appropriate configuration of processor components). For simplicity, various operations, acts, and/or functions are described herein as being performed “by a wireless communication device,” “by an initiator device,” and/or “by a responder device.” However, as will be appreciated, such operations, acts, and/or functions may actually be performed by specific components or combinations of components of the wireless communication device 300, such as the one or more processors 342, the one or more transceivers 310 and 320, the memory 340, the ultra-wideband component 348, etc.

In some aspects, UWB uses time of flight (ToF) to determine the distance between two or more enhanced ranging devices (ERDEVs). ToF is the propagation time that it takes for a radio frequency (RF) signal to travel from the transmitter to the receiver. The distance between the transmitter and receiver can be calculated by multiplying the ToF by the speed of light. Where a target device performs ranging procedures with multiple anchor devices (devices with known locations), the location of the target device can be determined based on the calculated distances between the target device and the anchor devices and the known locations of the anchor devices. The location of the target device may be determined by a positioning entity, which may be the target device itself, one of the anchor devices, a processing device communicatively coupled to the target device and/or the anchor devices, or a location server.

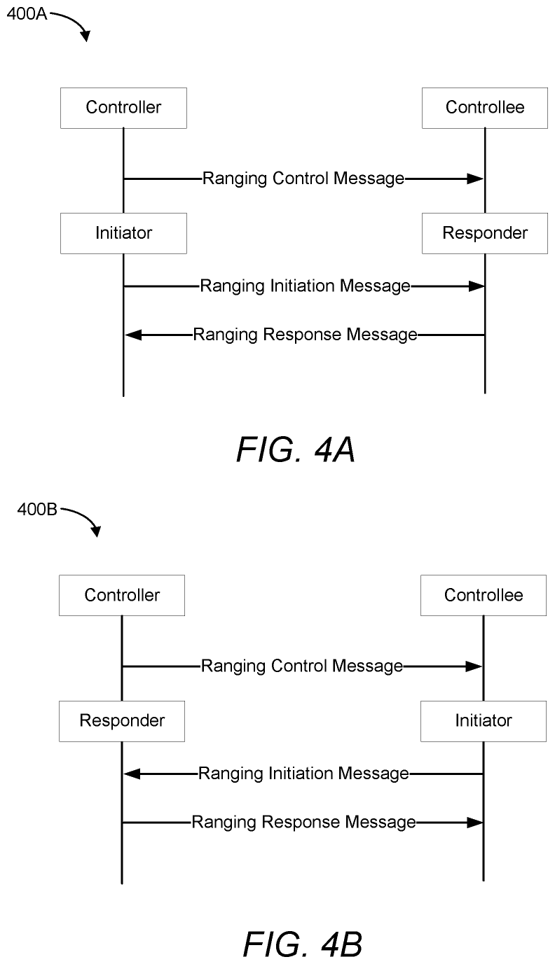

FIGS. 4A and 4B are diagrams 400A and 400B illustrating example ranging operations, according to aspects of the disclosure. The following nomenclature is used for ERDEVs. Controller: An ERDEV that controls the ranging and defines the ranging parameters by sending a ranging control message (RCM). Controlee: An ERDEV that utilizes the ranging parameters received from the controller in the RCM. Initiator (or an initiator device): An ERDEV that, following the RCM, initiates a ranging exchange by sending the first message of the exchange, the ranging initiation message (RIM). Responder (or a responder device): An ERDEV that responds to the ranging initiation message received from the initiator, with a ranging response message (RRM).

In some aspects, a controller can be configured as an initiator, and a controlee can be configured as a responder, as shown in FIG. 4A. In some aspects, a controller can be configured as a responder, and a controlee can be configured as an initiator, as shown in FIG. 4B. In some aspects, the initiator in FIG. 4A and FIG. 4B may correspond the initiator device described in FIG. 1, and the responder in FIG. 4A and FIG. 4B may correspond the responder device described in FIG. 1.

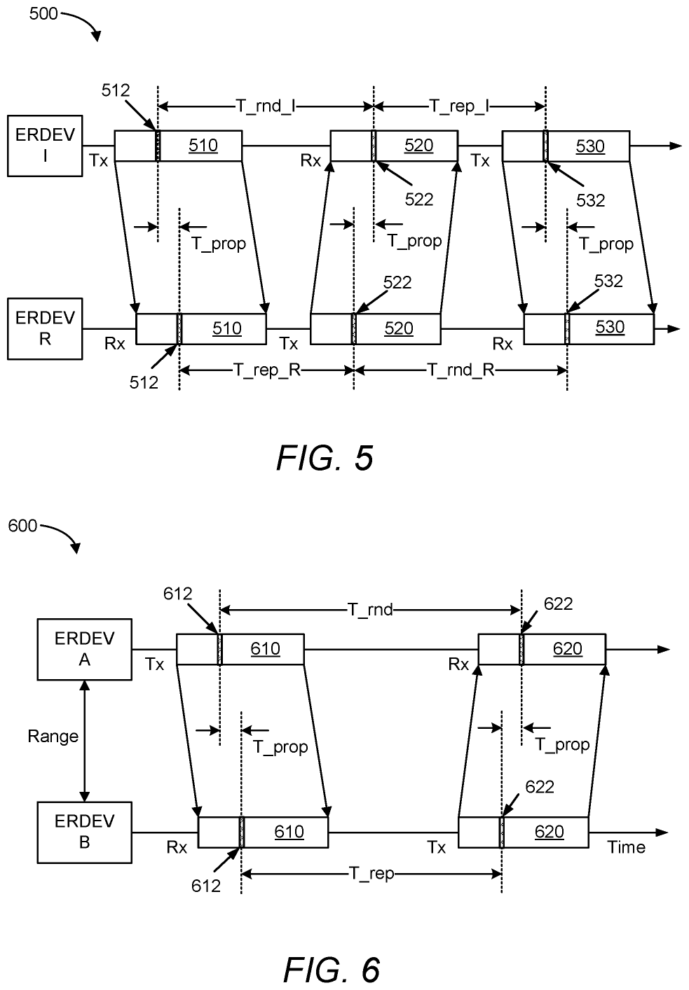

FIG. 5 is a diagram illustrating a double-sided two-way ranging (DS-TWR) procedure 500, according to aspects of the disclosure. The DS-TWR procedure 500 is performed between a first ERDEV acting as an initiator device (labeled “ERDEV I”) and a second ERDEV acting as a responder device (labeled “ERDEV R”). In a DS-TWR procedure 500, multiple exchanges are made between the two ERDEVs to mitigate the effect of clock skew.

In some aspects, the first ERDEV may transmit a message (e.g., a ranging initiation message, RIM) 510, which may include a ranging marker 512. The first ERDEV may timestamp the ranging marker 512 at the time of transmission thereof. The second ERDEV may receive the message 510 and timestamp the ranging marker 512 at the time of reception thereof. The ToF between the two ERDEVs (labeled “T_prop”) may correspond to the time difference between the (transmission) timestamp of the ranging marker 512 at first ERDEV and the (reception) timestamp of the ranging marker 512 at second ERDEV.

In some aspects, the second ERDEV may transmit a message (e.g., a ranging response message, RRM) 520, which may include a ranging marker 522. The second ERDEV may timestamp the ranging marker 522 at the time of transmission thereof. The first ERDEV may receive the message 520 and timestamp the ranging marker 522 at the time of reception thereof. The ToF between the two ERDEVs (labeled “T_prop”) may correspond to the time difference between the (transmission) timestamp of the ranging marker 522 at second ERDEV and the (reception) timestamp of the ranging marker 522 at first ERDEV. The first ERDEV may also obtain a round-trip time (labeled “T_rnd_I”) between the ranging marker 512 and the ranging marker 522 at the first ERDEV. In addition, the message 520 may include the information corresponding to the time between the ranging marker 512 and the ranging marker 522 at the second ERDEV (labeled “T_rep_R”).

In some aspects, the first ERDEV may further transmit a message (e.g., a ranging final message, RFM) 530, which may include a ranging marker 532. The first ERDEV may timestamp the ranging marker 532 at the time of transmission thereof. The second ERDEV may receive the message 530 and timestamp the ranging marker 532 at the time of reception thereof. The ToF between the two ERDEVs (labeled “T_prop”) may correspond to the time difference between the (transmission) timestamp of the ranging marker 532 at first ERDEV and the (reception) timestamp of the ranging marker 532 at second ERDEV. The second ERDEV may also obtain a round-trip time (labeled “T_rnd_R”) between the ranging marker 522 and the ranging marker 532 at the second ERDEV. In addition, the message 530 may include the information corresponding to the time between the ranging marker 522 and the ranging marker 532 at the first ERDEV (labeled “T_rep_I”).

In some aspects, the three message 510, 520, and 530 help correct the clock offset error between the transmitter and receiver (since the ERDEVs clocks may not be synchronized). In some aspects, the ToF between the two ERDEVs (T_prop) may be calculated as T_prop=(T_rnd_I×T_rnd_R−T_rep_R×T_rep_I)/(T_rnd_I+T_rnd_R+T_rep_R+T_rep_I). Note that either or both of the illustrated ERDEVs may perform additional ranging procedures with other ERDEVs.

In some aspects, considering the clock drift of the ERDEVs, the calculated ToF (T_prop) and the true ToF (T_prop′) may be determined based on the expression of T_prop=T_prop′+(e_I−e_R)×(T_rep_R−T_rep_I)/4, where e_I represents the clock drift of the first ERDEV, and e_R represents the clock drift of the second ERDEV. In some aspects, when the DS-TWR procedure 500 is configured to be symmetrical, the term (T_rep_R−T_rep_I) may be deemed zero and T_prop′ and T_prop may be deemed as the same.

FIG. 6 is a diagram illustrating a single-sided two-way ranging (SS-TWR) procedure 600, according to aspects of the disclosure. The SS-TWR procedure 600 is performed between a first ERDEV (labeled “ERDEV A”) and a second ERDEV (labeled “ERDEV B”).

In some aspects, the first ERDEV may transmit a message 610, which may include a ranging marker 612. The first ERDEV may timestamp the ranging marker 612 at the time of transmission thereof. The second ERDEV may receive the message 610 and timestamp the ranging marker 612 at the time of reception thereof. The ToF between the two ERDEVs (labeled “T_prop”) may correspond to the time difference between the (transmission) timestamp of the ranging marker 612 at first ERDEV and the (reception) timestamp of the ranging marker 612 at second ERDEV.

In some aspects, the second ERDEV may transmit a message 620, which may include a ranging marker 622. The second ERDEV may timestamp the ranging marker 622 at the time of transmission thereof. The first ERDEV may receive the message 620 and timestamp the ranging marker 622 at the time of reception thereof. The ToF between the two ERDEVs (labeled “T_prop”) may correspond to the time difference between the (transmission) timestamp of the ranging marker 622 at second ERDEV and the (reception) timestamp of the ranging marker 622 at first ERDEV. The first ERDEV may also obtain a round-trip time (labeled “T_rnd”) between the ranging marker 612 and the ranging marker 622 at the first ERDEV. In addition, the message 620 may include the information corresponding to the time between the ranging marker 612 and the ranging marker 622 at the second ERDEV (labeled “T_rep”).

In some aspects, the ToF between the two ERDEVs (T_prop) may be calculated as T_prop=½(T_rnd−T_rep). Note that either or both of the illustrated ERDEVs may perform additional ranging procedures with other ERDEVs.

In some aspects, the SS-TWR procedure 600 may be configured as a part of, or as a backup of, the DS-TWR procedure 500. In some aspects, while the first ERDEV is configured as an initiator device and the second ERDEV is configured as a responder device, the message 610 may be an RIM, and the message 620 may be a RRM. In some aspects, while the first ERDEV is configured as a responder device and the second ERDEV is configured as an initiator device, the message 610 may be an RRM, and the message 620 may be a RFM.

In some aspects, considering the clock drift of the ERDEVs, the calculated ToF (T_prop) and the true ToF (T_prop′) may be determined based on the expression of T_prop=T_prop′+(e_A−e_B)×T_rep/2, where e_A represents the clock drift of the first ERDEV, and e_B represents the clock drift of the second ERDEV.

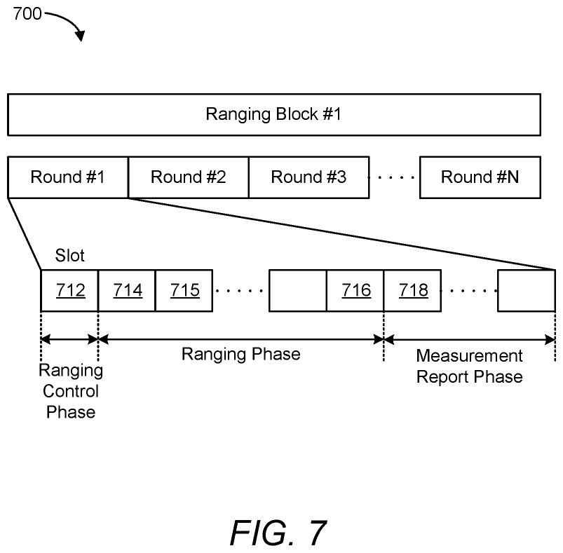

In some aspects, for time-scheduled or contention-free ranging in UWB, a positioning procedure based on UWB may be performed using consecutive ranging blocks. FIG. 7 is a diagram 700 illustrating an example ranging block structure, according to aspects of the disclosure. In some aspects, each block may have a duration of 200 ms. As shown in FIG. 7, each ranging block consists of ranging rounds, which in turn have several ranging slots. In some aspects, the number of rounds within a block and/or the number of slots within a round may be configured by the UWB controller.

In some aspects, within a ranging block, a single ranging round may be selected for the positioning procedure. In some aspects, the selected round index may be statically configured by the controller or selected as per a hopping pattern. In some aspects, the slot duration may range from 1 ms to 2.66 ms. In some aspects, the actual ranging message may only take a portion of the slot (e.g., a packet of about 150 us), and the remainder of the slot may be retained for processing delays.

In some aspects, each round consists of a single slot for a control phase, followed by one or more slots for a ranging phase and one or more slots for a measurement reporting phase.

In some aspects, during a first slot 712 of the selected round (e.g., Round #1), a controller may transmit an RCM to an initiator device and one or more responder devices for a positioning procedure based on an ultra-wideband RAT (e.g., UWB) and/or a non-ultra-wideband RAT (e.g., WiFi or Bluetooth®). In some aspects, the controller may be the initiator device or one of the one or more responder devices, and the controller may not need to transmit the RCM to itself.

In some aspects, during the ranging phase (e.g., during a first slot 714 of the ranging phase), the initiator device may transmit an RIM to the one or more responder devices.

Afterwards, the one or more responder devices may transmit corresponding one or more RRMs in respective slots (e.g., slot 715) as scheduled based on the RCM. The initiator device may then transmit an RFM to the one or more responder devices at a slot (e.g., slot 716) as scheduled based on the RCM after the slots for the RRMs. Finally, in some aspects, the initiator device and the one or more responder devices may transmit and/or receive one or more measurement report messages (MRMs) during the measurement report phase using the slot(s) (e.g., slot 718) as scheduled based on the RCM.

In some aspects, a frame for communications based on a non-ultra-wideband RAT may have a duration (e.g., 10 ms) comparable to a duration of a ranging round. In some aspects, a subframe for communications based on a non-ultra-wideband RAT may have a duration (e.g., 1 ms) comparable to a duration of a ranging slot. In some aspects, a collision of the signals from a communication system based on a non-ultra-wideband RAT and a message in a ranging slot based on an ultra-wideband RAT may likely reappear in subsequent ranging rounds or blocks. In some aspects, a retransmission scheme for the affected message (e.g., RIM, RRM, or RFM) may be implemented in order to allow the retransmission of the affected message without redo the entire message exchange sequence.

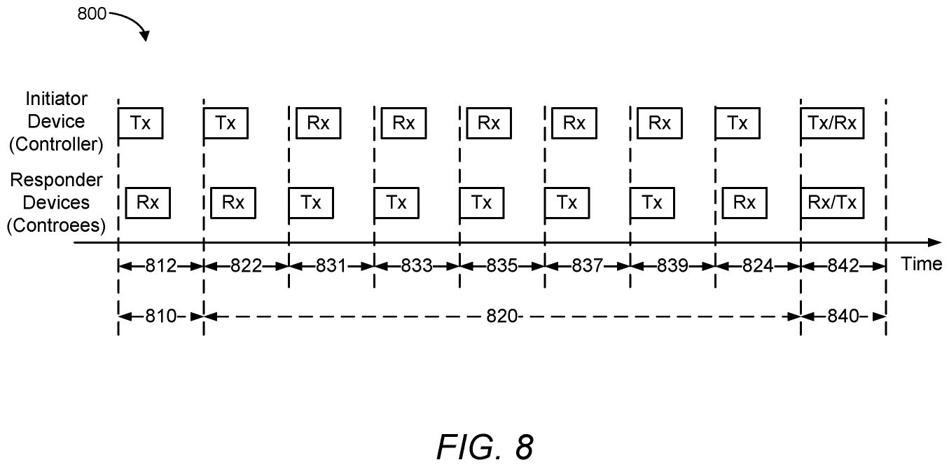

FIG. 8 is a diagram 800 illustrating an example ranging round for performing a positioning procedure (e.g., a DS-TWR procedure), according to aspects of the disclosure. In FIG. 8, time is represented horizontally. The “Tx” labeled in a box represents that a message may be transmitted, and “Rx” labeled in a box represents that a message transmitted within the same slot may be received. As shown in the diagram 800, a ranging round may include a control phase 810, a ranging phase 820, and a measurement reporting phase 840. In this non-limiting example, the control phase 810 may include a slot 812; the ranging phase 820 may include slots 822, 831, 833, 835, 837, 839, and 824; and the measurement reporting phase 840 may include a slot 842.

In this example, a positioning procedure may be performed to determine a location of an initiator device with respect to five (5) responder devices. For illustration purposes, the initiator device is configured as a controller of the positioning procedure, and the responder devices are configured as the controlees of the positioning procedure. In some aspects, this configuration may corresponding to a user device (e.g., a UE) being configured as the initiator device and the five responder devices being installed onboard a vehicle for determining if the user device is in close proximity to the vehicle.

In this example, the initiator device (as the controller) may transmit an RCM to the responder devices at slot 812. In some aspects, the RCM may include the schedule of the slots for the round, including at least how the slots of the ranging phase 820 and the measurement reporting phase 840 are arranged. The initiator device may transmit an RIM to the responder devices at slot 822 as scheduled based on the RCM. In some aspects, each of the responder devices may be assigned to transmit an RRM during a respective slot. Accordingly, the responder devices may transmit, and the initiator device may receive, respective RRMs at slot 831, 833, 835, 837, and 839. Afterwards, the initiator device may transmit an RFM at slot 824. At the end of the ranging round, the initiator device may transmit its measurement results to the responder devices at slot 842. In some aspects, the responder devices may transmit their measurement results to the initiator device at slot 842 or one or more other slots in the measurement reporting phase 840.

In some aspects, due to interference from other communication system(s), one or more of the messages (e.g., RIM, RRMs, and/or RFM) may not be successfully received by the receiving entity (or being referred to as the message is “dropped”). In some aspects, for a given responder device, if any of the RIM, RRM, or RFM for the DS-TWR procedure is dropped, the affected responder may not have sufficient information to participate in the DS-TWR positioning procedure.

In some aspects, considering presence of interference, the responder devices used in a DS-TWR procedure may include a subset of responder devices that are affected by the interference (e.g., at least one of RIM, RRM, and/or RFM in association with a corresponding responder device being dropped) and another subset of responder devices corresponding to the remaining responder devices that are not affected by the interference. In some aspects, if either RIM or RFM is not received by a responder device, the ToF between the initiator device and such responder device may not be estimated based on the DS-TWR procedure, but may still be estimated based on a SS-TWR procedure, albeit with degraded accuracy. In some aspects, if RRM from a responder device is not received by the initiator device, the ToF between the initiator device and such responder device may at best based on a one-way ranging procedure that is less accurate than a two-way ranging procedure.

In some aspects, in operation, the initiator device may transmit, based on a first messaging schedule for a current ranging round, an RIM to a plurality of responder devices based on a first RAT (e.g., at slot 822). The initiator device may receive, based on the first messaging schedule, one or more RRMs from a first subset R₁ of the responder devices based on the first RAT, the one or more RRMs may acknowledge reception of the RIM. The one or more RRMs may be received during the respective slots assigned to the respective responder devices according to the first messaging schedule (e.g., slots 831, 833, 835, 837, and 839). In some aspects, failure of receiving an RRM may be caused by the interference (i.e., the RRM is dropped). In some aspects, the initiator device may receive an RRM indicating that the corresponding responder device failed to receive the RIM (i.e., the RIM is dropped).

In some aspects, the initiator device may transmit, based on the first messaging schedule, an RFM to the plurality of responder devices based on the first RAT (e.g., at slot 824). In some aspects, the initiator device may further transmit, based on the first messaging schedule, a first measurement report message to the plurality of responder devices based on a second RAT (e.g., at slot 842). In some aspects, the initiator device may receive, based on the first messaging schedule, second measurement report messages from the plurality of responder devices based on the second RAT (e.g., at slot 842). In some aspects, the first RAT may correspond to an ultra-wideband RAT (e.g., UWB) based on a first channel bandwidth, and the second RAT may correspond to a short-range RAT (e.g., WiFi, Bluetooth®, or NFC) based on a second channel bandwidth that is one-third or less of the first channel bandwidth.

In some aspects, the first measurement report message from the initiator device may indicate the first subset R₁ of the plurality of responder devices as available for SS-TWR (i.e., with successful reception of RIM and RRM), a second subset R₂ of the plurality of responder devices from which a corresponding RRM or RIM is not deemed received (i.e., the responder device that does not receive the RIM or whose RRM is not received by the initiator device) based on the first messaging schedule as unavailable for two-way ranging, or both. In some aspects, the second measurement report messages from the responder devices may collectively indicate a third subset R₃ of the plurality of responder devices that is within the first subset R₁ and has successfully received the RFM as available for DS-TWR.

In some aspects, the first measurement report message may indicate whether individual responder devices of the plurality of responder devices as available for SS-TWR or unavailable for two-way ranging in a form of a bitmap (e.g., a sequence of bits) arranged according to an order of response transmission slots in the first messaging schedule to which the individual responder devices are assigned. For example, a bitmap “10110” may indicate that the responder devices corresponding to the slots 831, 835, and 837 are available for at least SS-TWR (with successful RIM and RRM) and thus may be candidates for DS-TWR (if having successful RFM). Also, the bitmap “10110” may indicate that the responder devices corresponding to the slots 833 and 839 are not available for two-way ranging.

In some aspects, as the initiator device may only determine whether it received the RRM successfully and whether its RIM was delivered successfully (based on the acknowledgement included in the received RRM), the responder devices, or a processing device (e.g., the processing device) coupled to the responder devices, may still need to verify if the RFM is successfully received by the corresponding responder devices in order to enable DS-TWR. In some aspects, the responder devices, or the processing device coupled to the responder devices, may determine a subset of the responder devices that are available for DS-TWR (i.e., with successful reception of RIM, RRM, and RFM) from first subset R₁ indicated in the first measurement report message.

In some aspects, the second measurement report messages may include updated bitmaps (e.g., based on updating the bitmap included in the first measurement report message) indicating whether the individual responder devices of the plurality of responder devices are available for DS-TWR. In some aspects, the updated bitmap may also be a sequence of bits arranged according to the order of response transmission slots in the first messaging schedule to which the individual responder devices are assigned. In one example, if a responder device is indicated as available for SS-TWR and indeed receives the RFM as scheduled, the updated bitmap may indicate that such responder device is available for DS-TWR. In another example, if a responder device is indicated as available for SS-TWR and does not receive the RFM as scheduled, the updated bitmap may indicate that such responder device is not available for DS-TWR.

In some aspects, the bitmaps included in the first measurement report message and/or the second measurement report messages may be used as an indicator of whether measurement results (e.g., time-of-arrival, angle of arrival (azimuth), angle of arrival (elevation), and/or figure-of-merit values) are included in the measurement report messages or to be decoded or processed. In one example, if a responder device has been indicated as unavailable for two-way ranging, the initiator may omit including any measurement results regarding that responder device in the first measurement report message, or a responder device or the processing device for determining the position of the initiator device may omit decoding any measurement results regarding that responder device from the first measurement report message. In one example, if a responder device has been indicated as unavailable for two-way ranging, such responder device may omit receiving the RFM. In some aspects, omitting reporting or decoding measurement results regarding a responder device unavailable for two-way ranging, or omitting receiving one or more ranging messages, may reduce processing time and/or reduce power consumption of the initiator device, the responder device(s), and/or the processing device.

In some aspects according to some ultra-wideband specifications (e.g., IEEE 802.15.4ab specification), one or more measurement report messages may be transmitted during the measurement reporting phase 840 using the first RAT (e.g., an ultra-wideband RAT). However, considering that the one or more measurement report messages using the first RAT may also be affected by the interference, the first measurement report message and/or the second measurement report messages indicating whether the responder devices as available for SS-TWR and/or DS-TWR may be transmitted based on the second RAT.

In some aspects, retransmission of the ranging messages may be scheduled in a following round of the subsequent ranging block based on the same schedule (e.g., one slot for each responder device). In some aspects, considering the past performance of the RRMs, retransmission of the RRMs may be scheduled in a manner that different ranging devices may be assigned with different numbers of slots. In some aspects, the initiator or the controller may determine a second messaging schedule for a subsequent ranging round in the current ranging block or in a subsequent ranging block based on the third subset R₃ of the plurality of responder devices, a fourth subset R₄ of the plurality of responder devices that is a complement of the third subset R₃ of the plurality of responder devices with respect to the plurality of responder devices, or both. In some aspects, the initiator device may transmit a control message indicating the second messaging schedule to the plurality of responder devices based on the second RAT.

In some aspects, the initiator or the controller may increase a number of response transmission slots (e.g., for RRMs) in the second messaging schedule assigned to a target responder device of the fourth subset R₄ of the plurality of responder devices than that in the first messaging schedule based on a number the third subset R₃ of the plurality of responder devices is less than a first reference value, a location of the target responder device together with the third subset R₃ of the plurality of responder devices improves a dilution of precision (GDOP) performance, or both. In some aspects, the initiator or the controller may increase a number of response transmission slots (e.g., for RRMs) in the second messaging schedule assigned to a target responder device of the third subset R₃ of the plurality of responder devices than that in the first messaging schedule based on a figure-of-merit associated with the target responder device is less than a second reference value.

In some aspects, the initiator or the controller may decrease a number of response transmission slots (e.g., for RRMs) in the second messaging schedule assigned to a target responder device of the third subset R₃ of the plurality of responder devices than that in the first messaging schedule based on the target responder was indicated as available for double-sided two-way ranging in a previous ranging round that is within a reference time duration (e.g., 500 ms to 1000 ms) or within a reference number of ranging rounds (e.g., 5 rounds) from the current ranging round, the target responder has been indicated as available for double-sided two-way ranging and a figure-of-merit associated with the target responder device is greater than a third reference value, or both.

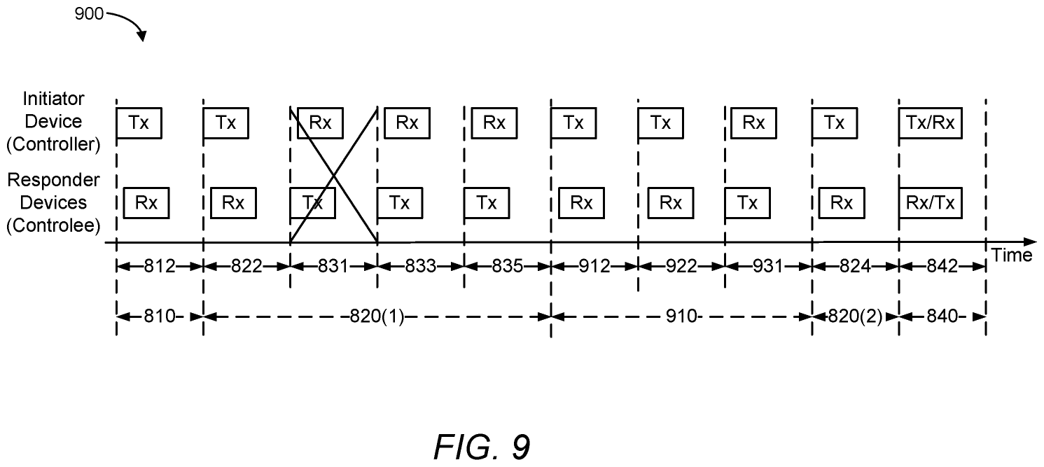

FIG. 9 is a diagram 900 illustrating another example ranging round for performing a positioning procedure (e.g., a DS-TWR procedure), according to aspects of the disclosure. In FIG. 9, time is represented horizontally. The “Tx” labeled in a box represents that a message may be transmitted, and “Rx” labeled in a box represents that a message transmitted within the same slot may be received. Also, the elements that are similar or the same as those depicted in FIG. 8 are given the same reference numbers, and detailed description thereof may be simplified or omitted.

As shown in the diagram 900, a ranging round may include a control phase 810, a ranging phase 820 (including a first portion 820(1) and a second portion 820(2)), and a measurement reporting phase 840. In this non-limiting example, the control phase 810 may include a slot 812; the first portion of the ranging phase 820(1) may include slots 822, 831, 833, and 835; the second portion of the ranging phase 820(2) may include a slot 824; and the measurement reporting phase 840 may include a slot 842.

In this example, a positioning procedure may be performed to determine a location of an initiator device with respect to three (3) responder devices. For illustration purposes, the initiator device is configured as a controller of the positioning procedure, and the responder devices are configured as the controlees of the positioning procedure. In some aspects, this configuration may corresponding to a user device (e.g., a UE) being configured as the initiator device and the three responder devices being installed onboard a vehicle for determining if the user device is in close proximity to the vehicle.

In this example, the initiator device (as the controller) may transmit an RCM to the responder devices at slot 812. In some aspects, the RCM may include the schedule of the slots for the round, including at least how the slots of the ranging phase 820 and the measurement reporting phase 840 are arranged. In this example, the round may further include a retransmission phase 910. In some aspects, the RCM may indicate where the retransmission phase 910 is arranged within the current ranging round. In some aspects, the retransmission phase 910 may include slots 912, 922, and 931 as a non-limiting example.

The initiator device may transmit an RIM to the responder devices at slot 822 as scheduled based on the RCM. In some aspects, each of the responder devices may be assigned to transmit an RRM during a respective slot. Accordingly, the responder devices may transmit, and the initiator device may receive, respective RRMs at slot 831, 833, and 835.

In this example, the initiator device however cannot successfully receive the RRM at slot 831 from a target responder device as scheduled based on the RCM, or the received RCM indicated that the target responder device cannot successfully receive the RIM at slot 822 (e.g., indicated by crossing out slot 831).

In some aspects, the initiator may schedule the transmission of a RCM from the target responder device using the retransmission phase 910 of the current ranging round. In some aspects, the initiator device may determine a supplemental messaging schedule for a portion of the current ranging round after the one or more ranging response messages being received (e.g., the retransmission phase 910). In some aspects, the supplemental messaging schedule may include assigning one or more response transmission slots to at least a portion of the plurality of responder devices that is a complement of the first subset of the plurality of responder devices (e.g., either having a dropped RIM or a dropped RRM) with respect to the plurality of responder devices prior to the ranging final message being transmitted.

In this example, to schedule retransmission regarding the target responder device, the initiator may transmit, at slot 912 based on the schedule indicated in the RCM within the same ranging round, a control message (e.g., a ranging control update message, RCUM) indicating the supplemental messaging schedule to the plurality of responder devices based on the second RAT (for robustness against interference). In some aspects, the supplemental messaging schedule may indicate a slot within the retransmission phase 910 for transmission of a supplemental RIM (e.g., slot 922) and one or more slots within the retransmission phase 910 for transmission of one or more supplemental RRM (e.g., slot 931).

In some aspects, the RCM at slot 812 may include a slot index for the control message (e.g., a slot index of slot 912) such that the responder devices may know when to wake up to receive the control message. In some aspects, the control message at slot 912 may include a bitmap indicating which responder device(s) are subject for retransmission within the retransmission phase 910, along with additional slot indices (within the same ranging phase) for the affected responders to retransmit respective supplemental RRMs.

In some aspects, the initiator may transmit, based on the supplemental messaging schedule, a supplemental RIM to the plurality of responder devices based on the first RAT (e.g., at slot 922). In some aspects, a target responder device may transmit, and the initiator device may receive, a supplemental RRM at slot 931 based on the supplemental messaging schedule included in the RCUM. Afterwards, the initiator device may transmit an RFM at slot 824. At the end of the ranging round, the initiator device may transmit its measurement results to the responder devices at slot 842. In some aspects, the responder devices may transmit their measurement results to the initiator device at slot 842 or one or more other slots in the measurement reporting phase 840.

As the retransmission (e.g., the supplemental RIM and the supplemental RRM(s)) is performed within the same ranging round, the supplemental RIM and the supplemental RRM(s) may enable more ranging together with the RIM and RRMs in the same ranging round rather than waiting until the next round. In some aspects, the processing time and positioning accuracy may be improved at the expense of some additional processing and power consumption within the same ranging round.

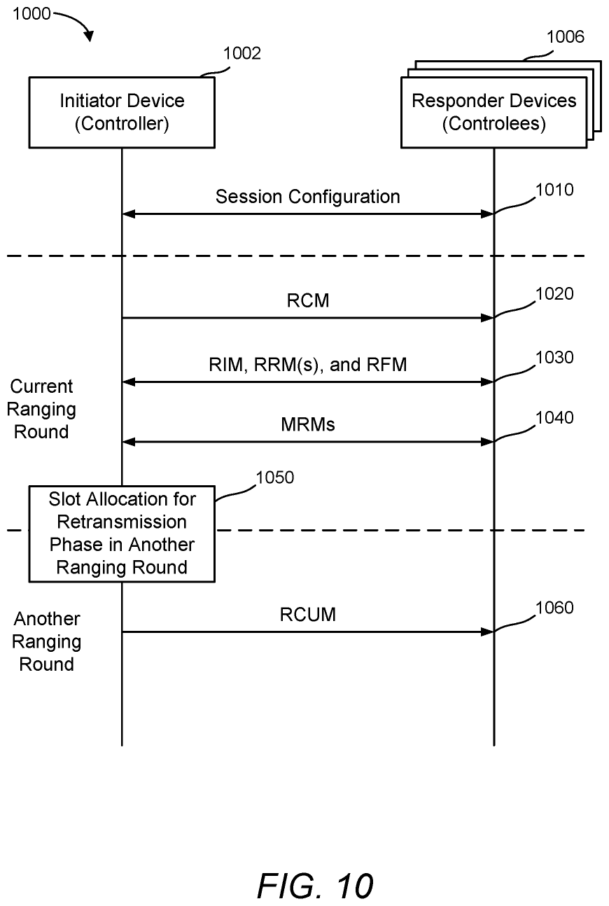

In some aspects, as a variation of the examples depicted in FIG. 8 and FIG. 9, the initiator device may use another ranging round (e.g., the following ranging round or a given ranging round in the following ranging block) as the retransmission phase. FIG. 10 is a diagram illustrating a message flow for performing such variation positioning procedure 1000, according to aspects of the disclosure. As shown in FIG. 10, the initiator device 1002 may be configured as a controller, and the responder devices 1006 may be configured as controlees.

In this procedure 1000, prior to the current ranging round, the initiator device 1002 (as the controller) and the responder devices 1006 (as the controlees) may exchange capability information at a session configuration stage 1010 indicating whether each one of the initiator device 1002 and the responder devices 1006 is capable of indicating two-way ranging (e.g., SS-TWR, DS-TWR, or both) in a message (e.g., in the form of a bitmap).

During the current ranging round, the initiator device 1002 may transmit an RCM to the responder devices 1006 at stage 1020, which may correspond to slot 812 in FIG. 8 or FIG. 9. In some aspects, the RCM may indicate a messaging schedule indicating how the slots during the ranging phase are assigned to the initiator device 1002 and the responder devices 1006. Next, the initiator device 1002 may transmit an RIM, the responder devices 1006 may transmit respective RRMs, and then the initiator device 1002 may transmit an RFM as illustrated in FIG. 8 during the ranging phase 820 at stage 1030. Afterwards, the initiator device 1002 and the responder devices 1006 may exchange MRMs as illustrated in FIG. 8 during the measurement reporting phrase 840 at stage 1040. In some aspects, the initiator device 1002 may transmit an MRM to the responder devices 1006 indicating if each one of the responder devices 1006 is available for SS-TWR (e.g., in the form of a bitmap). In some aspects, each one of the responder device 1006 may transmit an MRM to the initiator device 1002 indicating if the corresponding responder device is available for DS-TWR (e.g., in the form of another bitmap by updating the bitmap from the initiator device).

In some aspects, the initiator device 1006 (as the controller) may determine at stage 1050 a slot allocation for a retransmission phase in another ranging round (e.g., the following ranging round or a given ranging round in the following ranging block). In some aspects, the slot allocation may include the slot for an RCUM, a slot for a supplemental RIM, one or more slots for respective supplemental RRMs, a slot for a supplemental RFM, and/or one or more slots for supplemental MRMs.

In some aspects, the initiator device 1002 may transmit, to the responder devices 1006 at stage 1060, a control message (e.g., the RCUM) that provide the slot allocation for the retransmission phase at the start of the following ranging round or the following ranging block. In some aspects, the initiator device 1002 may transmit the control message indicating a second messaging schedule (e.g., the messaging schedule for the retransmission phase in the following ranging round or the following ranging block) to the plurality of responder devices 1006 based on the second RAT.

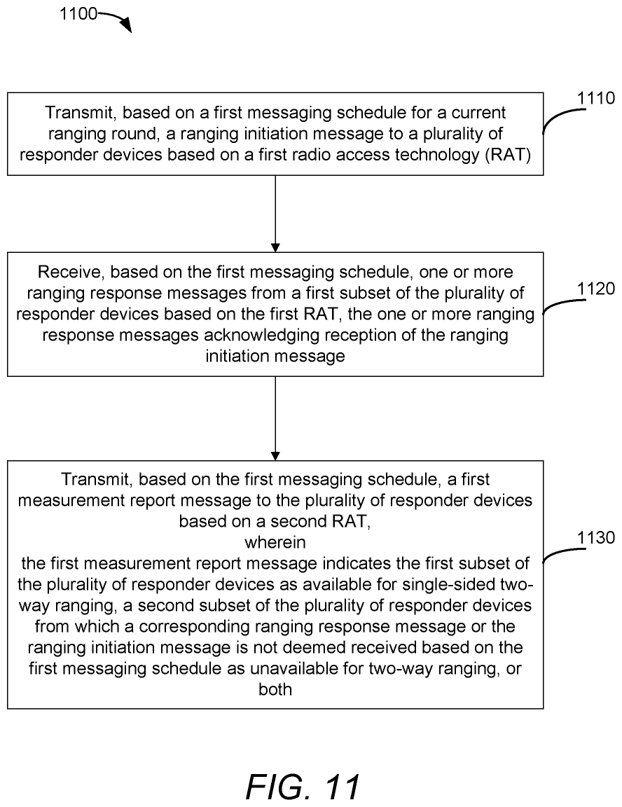

FIG. 11 is a flowchart illustrating a method 1100 of operating an initiator device, according to aspects of the disclosure. In some aspects, the initiator device in the method 1100 may correspond to the initiator device described in FIGS. 8-10. In some aspects, the initiator device may be a wireless communication device 300 described in FIG. 3; and the method 1100 may be performed by the one or more WWAN transceivers 310, the one or more short-range wireless transceivers 320, the one or more processors 342, the memory 340, and/or the ultra-wideband component 348, any or all of which may be considered means for performing one or more of the following operations of method 1100.

At operation 1110, the initiator device may transmit, based on a first messaging schedule for a current ranging round, a ranging initiation message (e.g., an RIM at slot 822 in FIG. 8 and FIG. 9 and/or an RIM at stage 1030 in FIG. 10) to a plurality of responder devices based on a first RAT. In some aspects, operation 1110 may be performed by the one or more WWAN transceivers 310, the one or more short-range wireless transceivers 320, the one or more processors 342, the memory 340, and/or the ultra-wideband component 348, any or all of which may be considered means for performing operation 1110.

At operation 1120, the initiator device may receive, based on the first messaging schedule, one or more ranging response messages from a first subset of the plurality of responder devices based on the first RAT, where the one or more ranging response messages acknowledging reception of the ranging initiation message (e.g., a subset of the RRMs at slots 831-839 in FIG. 8 and FIG. 9 and/or a subset of the RRMs at stage 1030 in FIG. 10 that are successfully received by the initiator device and acknowledging reception of the RIM). Based on the one or more ranging response messages, the initiator device may determine that the first subset of the plurality of responder devices is available for one-sided two-way ranging (and potentially available for two-sided two-way ranging). In some aspects, operation 1120 may be performed by the one or more WWAN transceivers 310, the one or more short-range wireless transceivers 320, the one or more processors 342, the memory 340, and/or the ultra-wideband component 348, any or all of which may be considered means for performing operation 1120.

At operation 1130, the initiator device may transmit, based on the first messaging schedule, a first measurement report message to the plurality of responder devices based on a second RAT (e.g., the MRM at slot 842 from the initiator device in FIG. 8 and FIG. 9 and/or an MRM from the initiator device at stage 1040 in FIG. 10). In some aspects, the first measurement report message may indicate the first subset of the plurality of responder devices as available for single-sided two-way ranging (e.g., SS-TWR), a second subset of the plurality of responder devices from which a corresponding ranging response message or the ranging initiation message is not deemed received based on the first messaging schedule as unavailable for two-way ranging, or both. In some aspects, the first measurement report message may indicate whether individual responder devices of the plurality of responder devices as available for single-sided two-way ranging or unavailable for single-sided two-way ranging in a form of a bitmap arranged according to an order of response transmission slots in the first messaging schedule to which the individual responder devices are assigned.

In some aspects, operation 1130 may be performed by the one or more WWAN transceivers 310, the one or more short-range wireless transceivers 320, the one or more processors 342, the memory 340, and/or the ultra-wideband component 348, any or all of which may be considered means for performing operation 1130.

In some aspects, the first RAT may correspond to an ultra-wideband radio access technology (e.g., UWB) based on a first channel bandwidth. In some aspects, the second RAT corresponds to a short-range radio access technology (e.g., WiFi or Bluetooth®) based on a second channel bandwidth that is one-third or less of the first channel bandwidth.

In some aspects, the initiator device may transmit, based on the first messaging schedule and prior to the first measurement report message being transmitted, a ranging final message (e.g., an RFM at slot 824 in FIG. 8 and FIG. 9 and/or an RFM at stage 1030 in FIG. 10) to the plurality of responder devices based on the first RAT. In some aspects, the initiator device may receive, based on the first messaging schedule, second measurement report messages from the plurality of responder devices (e.g., the MRMs from the responder devices at slot 842 in FIG. 8 and FIG. 9 and/or MRMs from the from the initiator device at stage 1040 in FIG. 10) based on the second RAT. In some aspects, the second measurement report messages may collectively indicate a third subset of the plurality of responder devices that is within the first subset and has successfully received the ranging final message as available for double-sided two-way ranging (e.g., DS-TWR).

In some aspects, the initiator device may determine a second messaging schedule for a subsequent ranging round in the current ranging block or in a subsequent ranging block based on the third subset of the plurality of responder devices, a fourth subset of the plurality of responder devices that is a complement of the third subset of the plurality of responder devices with respect to the plurality of responder devices, or both. In some aspects, the second messaging schedule may be for, e.g., a new ranging session. In some aspects, the initiator device may transmit a control message indicating the second messaging schedule to the plurality of responder devices based on the second RAT.

In some aspects, the initiator may increase a number of response transmission slots in the second messaging schedule assigned to a target responder device of the fourth subset of the plurality of responder devices than that in the first messaging schedule based on a number the third subset of the plurality of responder devices is less than a first reference value, a location of the target responder device together with the third subset of the plurality of responder devices improves a GDOP performance, or both. In some aspects, the initiator device may increase a number of response transmission slots in the second messaging schedule assigned to a target responder device of the third subset of the plurality of responder devices than that in the first messaging schedule based on a figure-of-merit associated with the target responder device is less than a second reference value.

In some aspects, the initiator device may decrease a number of response transmission slots in the second messaging schedule assigned to a target responder device of the third subset of the plurality of responder devices than that in the first messaging schedule based on the target responder was indicated as available for double-sided two-way ranging in a previous ranging round that is within a reference time duration or within a reference number of ranging rounds from the current ranging round, the target responder has been indicated as available for double-sided two-way ranging and a figure-of-merit associated with the target responder device is greater than a third reference value, or both.

In some aspects, the initiator device may determine a supplemental messaging schedule for a portion of the current ranging round after the one or more ranging response messages being received. In some aspects, the supplemental messaging schedule may be for retransmission of a current ranging session within the same ranging round or a following ranging round. In some aspects, the supplemental messaging schedule may assign one or more response transmission slots to at least a portion of the plurality of responder devices that is a complement of the first subset of the plurality of responder devices with respect to the plurality of responder devices prior to the ranging final message being transmitted.

In some aspects, the initiator device may transmit, based on the first messaging schedule at a start of a following ranging round or a following ranging block, a control message (e.g., the RCUM at slot 912 in FIG. 9 or the RCUM at stage 1060 in FIG. 10) indicating the supplemental messaging schedule to the plurality of responder devices based on the second RAT.

In some aspects, the initiator device may transmit, based on the supplemental messaging schedule, a supplemental ranging initiation message to the plurality of responder devices based on the first RAT. In some aspects, the initiator device may receive, based on the supplemental messaging schedule, one or more supplemental ranging response messages from the portion of the plurality of responder devices based on the first RAT. In some aspects, the first measurement report message may further indicate the portion of the plurality of responder devices as available for single-sided two-way ranging in addition to the first subset of the plurality of responder devices.

As will be appreciated, a technical advantage of the method 1100 is implementing a retransmission scheme for the affected message (e.g., RIM, RRM, or RFM) in a positioning procedure based on an ultra-wideband RAT. In some examples, an initiator device may determine whether each of the responder devices is available for a SS-TWR procedure and/or a DS-TWR procedure based on the messages transmitted or received according to a first messaging schedule, and determine a second messaging schedule or a supplemental messaging schedule for retransmission. Accordingly, the retransmission of dropped messages (e.g., RIM, RRM, or RFM) may be performed with reduced overhead, and a positioning procedure may thus be timely performed with improved accuracy by achieving DS-TWR in place of SS-TWR.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating an initiator device, the method comprising: transmitting, based on a first messaging schedule for a current ranging round, a ranging initiation message to a plurality of responder devices based on a first radio access technology (RAT); receiving, based on the first messaging schedule, one or more ranging response messages from a first subset of the plurality of responder devices based on the first RAT, the one or more ranging response messages acknowledging reception of the ranging initiation message; and transmitting, based on the first messaging schedule, a first measurement report message to the plurality of responder devices based on a second RAT, wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

Clause 2. The method of clause 1, further comprising: transmitting, based on the first messaging schedule and prior to the first measurement report message being transmitted, a ranging final message to the plurality of responder devices based on the first RAT; and receiving, based on the first messaging schedule, second measurement report messages from the plurality of responder devices based on the second RAT, the second measurement report messages collectively indicate a third subset of the plurality of responder devices that is within the first subset and has successfully received the ranging final message as available for double-sided two-way ranging.

Clause 3. The method of clause 2, further comprising: determining a second messaging schedule for a subsequent ranging round in a current ranging block or in a subsequent ranging block based on the third subset of the plurality of responder devices, a fourth subset of the plurality of responder devices that is a complement of the third subset of the plurality of responder devices with respect to the plurality of responder devices, or both.

Clause 4. The method of clause 3, further comprising: increasing a number of response transmission slots in the second messaging schedule assigned to a target responder device of the fourth subset of the plurality of responder devices than that in the first messaging schedule based on: a number the third subset of the plurality of responder devices is less than a first reference value, a location of the target responder device together with the third subset of the plurality of responder devices improves a dilution of precision (GDOP) performance, or both.

Clause 5. The method of any of clauses 3 to 4, further comprising: increasing a number of response transmission slots in the second messaging schedule assigned to a target responder device of the third subset of the plurality of responder devices than that in the first messaging schedule based on: a figure-of-merit associated with the target responder device is less than a second reference value.

Clause 6. The method of any of clauses 3 to 5, further comprising: decreasing a number of response transmission slots in the second messaging schedule assigned to a target responder device of the third subset of the plurality of responder devices than that in the first messaging schedule based on: the target responder device was indicated as available for double-sided two-way ranging in a previous ranging round that is within a reference time duration or within a reference number of ranging rounds from the current ranging round, the target responder device has been indicated as available for double-sided two-way ranging and a figure-of-merit associated with the target responder device is greater than a third reference value, or both.

Clause 7. The method of any of clauses 3 to 6, further comprising: transmitting a control message indicating the second messaging schedule to the plurality of responder devices based on the second RAT.

Clause 8. The method of clause 2, further comprising: determining a supplemental messaging schedule for a portion of the current ranging round after the one or more ranging response messages being received, the supplemental messaging schedule including assigning one or more response transmission slots to at least a portion of the plurality of responder devices that is a complement of the first subset of the plurality of responder devices with respect to the plurality of responder devices prior to the ranging final message being transmitted; and transmitting, based on the first messaging schedule or at a start of a following ranging round or a following ranging block, a control message indicating the supplemental messaging schedule to the plurality of responder devices based on the second RAT.

Clause 9. The method of clause 8, further comprising: transmitting, based on the supplemental messaging schedule, a supplemental ranging initiation message to the plurality of responder devices based on the first RAT; and receiving, based on the supplemental messaging schedule, one or more supplemental ranging response messages from the portion of the plurality of responder devices based on the first RAT.

Clause 10. The method of clause 9, wherein: the first measurement report message further indicates the portion of the plurality of responder devices as available for single-sided two-way ranging.

Clause 11. The method of any of clauses 1 to 10, wherein: the first measurement report message indicates whether individual responder devices of the plurality of responder devices as available for single-sided two-way ranging or unavailable for single-sided two-way ranging in a form of a bitmap arranged according to an order of response transmission slots in the first messaging schedule to which the individual responder devices are assigned.

Clause 12. The method of any of clauses 1 to 11, wherein: the first RAT corresponds to an ultra-wideband radio access technology based on a first channel bandwidth, and the second RAT corresponds to a short-range radio access technology based on a second channel bandwidth that is one-third or less of the first channel bandwidth.

Clause 13. An initiator device, comprising: one or more memories; one or more transceivers; and one or more processors communicatively coupled to the one or more memories and the one or more transceivers, the one or more processors, either alone or in combination, configured to: transmit, via the one or more transceivers based on a first messaging schedule for a current ranging round, a ranging initiation message to a plurality of responder devices based on a first radio access technology (RAT); receive, via the one or more transceivers based on the first messaging schedule, one or more ranging response messages from a first subset of the plurality of responder devices based on the first RAT, the one or more ranging response messages acknowledging reception of the ranging initiation message; and transmit, via the one or more transceivers, based on the first messaging schedule, a first measurement report message to the plurality of responder devices based on a second RAT, wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

Clause 14. The initiator device of clause 13, wherein the one or more processors, either alone or in combination, are further configured to: transmit, via the one or more transceivers based on the first messaging schedule and prior to the first measurement report message being transmitted, a ranging final message to the plurality of responder devices based on the first RAT; and receive, via the one or more transceivers based on the first messaging schedule, second measurement report messages from the plurality of responder devices based on the second RAT, the second measurement report messages collectively indicate a third subset of the plurality of responder devices that is within the first subset and has successfully received the ranging final message as available for double-sided two-way ranging.

Clause 15. The initiator device of clause 14, wherein the one or more processors, either alone or in combination, are further configured to: determine a second messaging schedule for a subsequent ranging round in a current ranging block or in a subsequent ranging block based on the third subset of the plurality of responder devices, a fourth subset of the plurality of responder devices that is a complement of the third subset of the plurality of responder devices with respect to the plurality of responder devices, or both.

Clause 16. The initiator device of clause 15, wherein the one or more processors, either alone or in combination, are further configured to: increase a number of response transmission slots in the second messaging schedule assigned to a target responder device of the fourth subset of the plurality of responder devices than that in the first messaging schedule based on: a number the third subset of the plurality of responder devices is less than a first reference value, a location of the target responder device together with the third subset of the plurality of responder devices improves a dilution of precision (GDOP) performance, or both.

Clause 17. The initiator device of any of clauses 15 to 16, wherein the one or more processors, either alone or in combination, are further configured to: increase a number of response transmission slots in the second messaging schedule assigned to a target responder device of the third subset of the plurality of responder devices than that in the first messaging schedule based on: a figure-of-merit associated with the target responder device is less than a second reference value.

Clause 18. The initiator device of any of clauses 15 to 17, wherein the one or more processors, either alone or in combination, are further configured to: decrease a number of response transmission slots in the second messaging schedule assigned to a target responder device of the third subset of the plurality of responder devices than that in the first messaging schedule based on: the target responder device was indicated as available for double-sided two-way ranging in a previous ranging round that is within a reference time duration or within a reference number of ranging rounds from the current ranging round, the target responder device has been indicated as available for double-sided two-way ranging and a figure-of-merit associated with the target responder device is greater than a third reference value, or both.

Clause 19. The initiator device of any of clauses 15 to 18, wherein the one or more processors, either alone or in combination, are further configured to: transmit, via the one or more transceivers, a control message indicating the second messaging schedule to the plurality of responder devices based on the second RAT.

Clause 20. The initiator device of clause 14, wherein the one or more processors, either alone or in combination, are further configured to: determine a supplemental messaging schedule for a portion of the current ranging round after the one or more ranging response messages being received, the supplemental messaging schedule including assigning one or more response transmission slots to at least a portion of the plurality of responder devices that is a complement of the first subset of the plurality of responder devices with respect to the plurality of responder devices prior to the ranging final message being transmitted; and transmit, via the one or more transceivers based on the first messaging schedule or at a start of a following ranging round or a following ranging block, a control message indicating the supplemental messaging schedule to the plurality of responder devices based on the second RAT.

Clause 21. The initiator device of clause 20, wherein the one or more processors, either alone or in combination, are further configured to: transmit, via the one or more transceivers based on the supplemental messaging schedule, a supplemental ranging initiation message to the plurality of responder devices based on the first RAT; and receive, via the one or more transceivers based on the supplemental messaging schedule, one or more supplemental ranging response messages from the portion of the plurality of responder devices based on the first RAT.

Clause 22. The initiator device of clause 21, wherein: the first measurement report message further indicates the portion of the plurality of responder devices as available for single-sided two-way ranging.

Clause 23. The initiator device of any of clauses 13 to 22, wherein: the first measurement report message indicates whether individual responder devices of the plurality of responder devices as available for single-sided two-way ranging or unavailable for single-sided two-way ranging in a form of a bitmap arranged according to an order of response transmission slots in the first messaging schedule to which the individual responder devices are assigned.

Clause 24. The initiator device of any of clauses 13 to 23, wherein: the first RAT corresponds to an ultra-wideband radio access technology based on a first channel bandwidth, and the second RAT corresponds to a short-range radio access technology based on a second channel bandwidth that is one-third or less of the first channel bandwidth.

Clause 25. An initiator device, comprising: means for transmitting, based on a first messaging schedule for a current ranging round, a ranging initiation message to a plurality of responder devices based on a first radio access technology (RAT); means for receiving, based on the first messaging schedule, one or more ranging response messages from a first subset of the plurality of responder devices based on the first RAT, the one or more ranging response messages acknowledging reception of the ranging initiation message; and means for transmitting, based on the first messaging schedule, a first measurement report message to the plurality of responder devices based on a second RAT, wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

Clause 26. The initiator device of clause 25, further comprising: means for transmitting, based on the first messaging schedule and prior to the first measurement report message being transmitted, a ranging final message to the plurality of responder devices based on the first RAT; and means for receiving, based on the first messaging schedule, second measurement report messages from the plurality of responder devices based on the second RAT, the second measurement report messages collectively indicate a third subset of the plurality of responder devices that is within the first subset and has successfully received the ranging final message as available for double-sided two-way ranging.

Clause 27. The initiator device of clause 26, further comprising: means for determining a second messaging schedule for a subsequent ranging round in a current ranging block or in a subsequent ranging block based on the third subset of the plurality of responder devices, a fourth subset of the plurality of responder devices that is a complement of the third subset of the plurality of responder devices with respect to the plurality of responder devices, or both.

Clause 28. The initiator device of clause 27, further comprising: means for increasing a number of response transmission slots in the second messaging schedule assigned to a target responder device of the fourth subset of the plurality of responder devices than that in the first messaging schedule based on: a number the third subset of the plurality of responder devices is less than a first reference value, a location of the target responder device together with the third subset of the plurality of responder devices improves a dilution of precision (GDOP) performance, or both.

Clause 29. The initiator device of any of clauses 27 to 28, further comprising: means for increasing a number of response transmission slots in the second messaging schedule assigned to a target responder device of the third subset of the plurality of responder devices than that in the first messaging schedule based on: a figure-of-merit associated with the target responder device is less than a second reference value.

Clause 30. The initiator device of any of clauses 27 to 29, further comprising: means for decreasing a number of response transmission slots in the second messaging schedule assigned to a target responder device of the third subset of the plurality of responder devices than that in the first messaging schedule based on: the target responder device was indicated as available for double-sided two-way ranging in a previous ranging round that is within a reference time duration or within a reference number of ranging rounds from the current ranging round, the target responder device has been indicated as available for double-sided two-way ranging and a figure-of-merit associated with the target responder device is greater than a third reference value, or both.

Clause 31. The initiator device of any of clauses 27 to 30, further comprising: means for transmitting a control message indicating the second messaging schedule to the plurality of responder devices based on the second RAT.

Clause 32. The initiator device of clause 26, further comprising: means for determining a supplemental messaging schedule for a portion of the current ranging round after the one or more ranging response messages being received, the supplemental messaging schedule including assigning one or more response transmission slots to at least a portion of the plurality of responder devices that is a complement of the first subset of the plurality of responder devices with respect to the plurality of responder devices prior to the ranging final message being transmitted; and means for transmitting, based on the first messaging schedule or at a start of a following ranging round or a following ranging block, a control message indicating the supplemental messaging schedule to the plurality of responder devices based on the second RAT.

Clause 33. The initiator device of clause 32, further comprising: means for transmitting, based on the supplemental messaging schedule, a supplemental ranging initiation message to the plurality of responder devices based on the first RAT; and means for receiving, based on the supplemental messaging schedule, one or more supplemental ranging response messages from the portion of the plurality of responder devices based on the first RAT.

Clause 34. The initiator device of clause 33, wherein: the first measurement report message further indicates the portion of the plurality of responder devices as available for single-sided two-way ranging.

Clause 35. The initiator device of any of clauses 25 to 34, wherein: the first measurement report message indicates whether individual responder devices of the plurality of responder devices as available for single-sided two-way ranging or unavailable for single-sided two-way ranging in a form of a bitmap arranged according to an order of response transmission slots in the first messaging schedule to which the individual responder devices are assigned.

Clause 36. The initiator device of any of clauses 25 to 35, wherein: the first RAT corresponds to an ultra-wideband radio access technology based on a first channel bandwidth, and the second RAT corresponds to a short-range radio access technology based on a second channel bandwidth that is one-third or less of the first channel bandwidth.

Clause 37. A non-transitory computer-readable medium storing computer-executable instructions that, when executed by an initiator device, cause the initiator device to: transmit, based on a first messaging schedule for a current ranging round, a ranging initiation message to a plurality of responder devices based on a first radio access technology (RAT); receive, based on the first messaging schedule, one or more ranging response messages from a first subset of the plurality of responder devices based on the first RAT, the one or more ranging response messages acknowledging reception of the ranging initiation message; and transmit, based on the first messaging schedule, a first measurement report message to the plurality of responder devices based on a second RAT, wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

Clause 38. The non-transitory computer-readable medium of clause 37, further comprising computer-executable instructions that, when executed by the initiator device, cause the initiator device to: transmit, based on the first messaging schedule and prior to the first measurement report message being transmitted, a ranging final message to the plurality of responder devices based on the first RAT; and receive, based on the first messaging schedule, second measurement report messages from the plurality of responder devices based on the second RAT, the second measurement report messages collectively indicate a third subset of the plurality of responder devices that is within the first subset and has successfully received the ranging final message as available for double-sided two-way ranging.

Clause 39. The non-transitory computer-readable medium of clause 38, further comprising computer-executable instructions that, when executed by the initiator device, cause the initiator device to: determine a second messaging schedule for a subsequent ranging round in a current ranging block or in a subsequent ranging block based on the third subset of the plurality of responder devices, a fourth subset of the plurality of responder devices that is a complement of the third subset of the plurality of responder devices with respect to the plurality of responder devices, or both.

Clause 40. The non-transitory computer-readable medium of clause 39, further comprising computer-executable instructions that, when executed by the initiator device, cause the initiator device to: increase a number of response transmission slots in the second messaging schedule assigned to a target responder device of the fourth subset of the plurality of responder devices than that in the first messaging schedule based on: a number the third subset of the plurality of responder devices is less than a first reference value, a location of the target responder device together with the third subset of the plurality of responder devices improves a dilution of precision (GDOP) performance, or both.

Clause 41. The non-transitory computer-readable medium of any of clauses 39 to 40, further comprising computer-executable instructions that, when executed by the initiator device, cause the initiator device to: increase a number of response transmission slots in the second messaging schedule assigned to a target responder device of the third subset of the plurality of responder devices than that in the first messaging schedule based on: a figure-of-merit associated with the target responder device is less than a second reference value.

Clause 42. The non-transitory computer-readable medium of any of clauses 39 to 41, further comprising computer-executable instructions that, when executed by the initiator device, cause the initiator device to: decrease a number of response transmission slots in the second messaging schedule assigned to a target responder device of the third subset of the plurality of responder devices than that in the first messaging schedule based on: the target responder device was indicated as available for double-sided two-way ranging in a previous ranging round that is within a reference time duration or within a reference number of ranging rounds from the current ranging round, the target responder device has been indicated as available for double-sided two-way ranging and a figure-of-merit associated with the target responder device is greater than a third reference value, or both.

Clause 43. The non-transitory computer-readable medium of any of clauses 39 to 42, further comprising computer-executable instructions that, when executed by the initiator device, cause the initiator device to: transmit a control message indicating the second messaging schedule to the plurality of responder devices based on the second RAT.

Clause 44. The non-transitory computer-readable medium of clause 38, further comprising computer-executable instructions that, when executed by the initiator device, cause the initiator device to: determine a supplemental messaging schedule for a portion of the current ranging round after the one or more ranging response messages being received, the supplemental messaging schedule including assigning one or more response transmission slots to at least a portion of the plurality of responder devices that is a complement of the first subset of the plurality of responder devices with respect to the plurality of responder devices prior to the ranging final message being transmitted; and transmit, based on the first messaging schedule or at a start of a following ranging round or a following ranging block, a control message indicating the supplemental messaging schedule to the plurality of responder devices based on the second RAT.

Clause 45. The non-transitory computer-readable medium of clause 44, further comprising computer-executable instructions that, when executed by the initiator device, cause the initiator device to: transmit, based on the supplemental messaging schedule, a supplemental ranging initiation message to the plurality of responder devices based on the first RAT; and receive, based on the supplemental messaging schedule, one or more supplemental ranging response messages from the portion of the plurality of responder devices based on the first RAT.

Clause 46. The non-transitory computer-readable medium of clause 45, wherein: the first measurement report message further indicates the portion of the plurality of responder devices as available for single-sided two-way ranging.

Clause 47. The non-transitory computer-readable medium of any of clauses 37 to 46, wherein: the first measurement report message indicates whether individual responder devices of the plurality of responder devices as available for single-sided two-way ranging or unavailable for single-sided two-way ranging in a form of a bitmap arranged according to an order of response transmission slots in the first messaging schedule to which the individual responder devices are assigned.

Clause 48. The non-transitory computer-readable medium of any of clauses 37 to 47, wherein: the first RAT corresponds to an ultra-wideband radio access technology based on a first channel bandwidth, and the second RAT corresponds to a short-range radio access technology based on a second channel bandwidth that is one-third or less of the first channel bandwidth.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of operating an initiator device, the method comprising:
transmitting, based on a first messaging schedule for a current ranging round, a ranging initiation message to a plurality of responder devices based on a first radio access technology (RAT);
receiving, based on the first messaging schedule, one or more ranging response messages from a first subset of the plurality of responder devices based on the first RAT, the one or more ranging response messages acknowledging reception of the ranging initiation message; and
transmitting, based on the first messaging schedule, a first measurement report message to the plurality of responder devices based on a second RAT,
wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

2. The method of claim 1, further comprising:
transmitting, based on the first messaging schedule and prior to the first measurement report message being transmitted, a ranging final message to the plurality of responder devices based on the first RAT; and
receiving, based on the first messaging schedule, second measurement report messages from the plurality of responder devices based on the second RAT, the second measurement report messages collectively indicate a third subset of the plurality of responder devices that is within the first subset and has successfully received the ranging final message as available for double-sided two-way ranging.

3. The method of claim 2, further comprising:
determining a second messaging schedule for a subsequent ranging round in a current ranging block or in a subsequent ranging block based on the third subset of the plurality of responder devices, a fourth subset of the plurality of responder devices that is a complement of the third subset of the plurality of responder devices with respect to the plurality of responder devices, or both.

4. The method of claim 3, further comprising:
transmitting a control message indicating the second messaging schedule to the plurality of responder devices based on the second RAT.

5. The method of claim 2, further comprising:
determining a supplemental messaging schedule for a portion of the current ranging round after the one or more ranging response messages being received, the supplemental messaging schedule including assigning one or more response transmission slots to at least a portion of the plurality of responder devices that is a complement of the first subset of the plurality of responder devices with respect to the plurality of responder devices prior to the ranging final message being transmitted; and
transmitting, based on the first messaging schedule or at a start of a following ranging round or a following ranging block, a control message indicating the supplemental messaging schedule to the plurality of responder devices based on the second RAT.

6. The method of claim 1, wherein:
the first measurement report message indicates whether individual responder devices of the plurality of responder devices as available for single-sided two-way ranging or unavailable for single-sided two-way ranging in a form of a bitmap arranged according to an order of response transmission slots in the first messaging schedule to which the individual responder devices are assigned.

7. The method of claim 1, wherein:
the first RAT corresponds to an ultra-wideband radio access technology based on a first channel bandwidth, and
the second RAT corresponds to a short-range radio access technology based on a second channel bandwidth that is one-third or less of the first channel bandwidth.

8. An initiator device, comprising:
one or more memories;
one or more transceivers; and
one or more processors communicatively coupled to the one or more memories and the one or more transceivers, the one or more processors, either alone or in combination, configured to:
transmit, via the one or more transceivers based on a first messaging schedule for a current ranging round, a ranging initiation message to a plurality of responder devices based on a first radio access technology (RAT);
receive, via the one or more transceivers based on the first messaging schedule, one or more ranging response messages from a first subset of the plurality of responder devices based on the first RAT, the one or more ranging response messages acknowledging reception of the ranging initiation message; and
transmit, via the one or more transceivers, based on the first messaging schedule, a first measurement report message to the plurality of responder devices based on a second RAT,
wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.

9. The initiator device of claim 8, wherein the one or more processors, either alone or in combination, are further configured to:
transmit, via the one or more transceivers based on the first messaging schedule and prior to the first measurement report message being transmitted, a ranging final message to the plurality of responder devices based on the first RAT; and
receive, via the one or more transceivers based on the first messaging schedule, second measurement report messages from the plurality of responder devices based on the second RAT, the second measurement report messages collectively indicate a third subset of the plurality of responder devices that is within the first subset and has successfully received the ranging final message as available for double-sided two-way ranging.

10. The initiator device of claim 9, wherein the one or more processors, either alone or in combination, are further configured to:
determine a second messaging schedule for a subsequent ranging round in a current ranging block or in a subsequent ranging block based on the third subset of the plurality of responder devices, a fourth subset of the plurality of responder devices that is a complement of the third subset of the plurality of responder devices with respect to the plurality of responder devices, or both.

11. The initiator device of claim 10, wherein the one or more processors, either alone or in combination, are further configured to:
increase a number of response transmission slots in the second messaging schedule assigned to a target responder device of the fourth subset of the plurality of responder devices than that in the first messaging schedule based on:
a number the third subset of the plurality of responder devices is less than a first reference value,
a location of the target responder device together with the third subset of the plurality of responder devices improves a dilution of precision (GDOP) performance, or
both.

12. The initiator device of claim 10, wherein the one or more processors, either alone or in combination, are further configured to:
increase a number of response transmission slots in the second messaging schedule assigned to a target responder device of the third subset of the plurality of responder devices than that in the first messaging schedule based on:
a figure-of-merit associated with the target responder device is less than a second reference value.

13. The initiator device of claim 10, wherein the one or more processors, either alone or in combination, are further configured to:
decrease a number of response transmission slots in the second messaging schedule assigned to a target responder device of the third subset of the plurality of responder devices than that in the first messaging schedule based on:
the target responder device was indicated as available for double-sided two-way ranging in a previous ranging round that is within a reference time duration or within a reference number of ranging rounds from the current ranging round,
the target responder device has been indicated as available for double-sided two-way ranging and a figure-of-merit associated with the target responder device is greater than a third reference value, or
both.

14. The initiator device of claim 10, wherein the one or more processors, either alone or in combination, are further configured to:
transmit, via the one or more transceivers, a control message indicating the second messaging schedule to the plurality of responder devices based on the second RAT.

15. The initiator device of claim 9, wherein the one or more processors, either alone or in combination, are further configured to:
determine a supplemental messaging schedule for a portion of the current ranging round after the one or more ranging response messages being received, the supplemental messaging schedule including assigning one or more response transmission slots to at least a portion of the plurality of responder devices that is a complement of the first subset of the plurality of responder devices with respect to the plurality of responder devices prior to the ranging final message being transmitted; and
transmit, via the one or more transceivers based on the first messaging schedule or at a start of a following ranging round or a following ranging block, a control message indicating the supplemental messaging schedule to the plurality of responder devices based on the second RAT.

16. The initiator device of claim 15, wherein the one or more processors, either alone or in combination, are further configured to:
transmit, via the one or more transceivers based on the supplemental messaging schedule, a supplemental ranging initiation message to the plurality of responder devices based on the first RAT; and
receive, via the one or more transceivers based on the supplemental messaging schedule, one or more supplemental ranging response messages from the portion of the plurality of responder devices based on the first RAT.

17. The initiator device of claim 16, wherein:
the first measurement report message further indicates the portion of the plurality of responder devices as available for single-sided two-way ranging.

18. The initiator device of claim 8, wherein:
the first measurement report message indicates whether individual responder devices of the plurality of responder devices as available for single-sided two-way ranging or unavailable for single-sided two-way ranging in a form of a bitmap arranged according to an order of response transmission slots in the first messaging schedule to which the individual responder devices are assigned.

19. The initiator device of claim 8, wherein:
the first RAT corresponds to an ultra-wideband radio access technology based on a first channel bandwidth, and
the second RAT corresponds to a short-range radio access technology based on a second channel bandwidth that is one-third or less of the first channel bandwidth.

20. A non-transitory computer-readable medium storing computer-executable instructions that, when executed by an initiator device, cause the initiator device to:
transmit, based on a first messaging schedule for a current ranging round, a ranging initiation message to a plurality of responder devices based on a first radio access technology (RAT);
receive, based on the first messaging schedule, one or more ranging response messages from a first subset of the plurality of responder devices based on the first RAT, the one or more ranging response messages acknowledging reception of the ranging initiation message; and
transmit, based on the first messaging schedule, a first measurement report message to the plurality of responder devices based on a second RAT,
wherein the first measurement report message indicates the first subset of the plurality of responder devices as available for single-sided two-way ranging, a second subset of the plurality of responder devices from which a corresponding ranging response message or the ranging initiation message is not deemed received based on the first messaging schedule as unavailable for two-way ranging, or both.
